(19) United States
(12) Patent Application Publication
(10) Pub. No.: US 2016/0008962 A1
(43) Pub. Date: Jan. 14, 2016

(54) RATCHET WRENCH WITH FIXING STRUCTURE

(71) Applicant: CHANG Po-Yen, Taichung City (TW)

(72) Inventor: CHANG Po-Yen, Taichung City (TW)

(21) Appl. No.: 14/330,000

(22) Filed: Jul. 14, 2014

(51) Int. Cl. B25B 23/00; B25B 13/46

(52) U.S. Cl. CPC B25B 23/0014; B25B 13/463

(57) ABSTRACT

A ratchet wrench with a fixing structure contains: an operating handle, a driving head, an accommodating cavity, and a first opening. A toothed block is accommodated in the accommodating cavity and has an octagonal hole. An actuating portion is accommodated in the octagonal hole and has an octagonal ball, an upper disc, a lower disc, a peripheral groove defined between the upper disc and the lower disc, and a connecting stem. The octagonal ball has at least one first aperture, a spring and a cap which are both mounted in the at least one first aperture, and the actuating portion also has a second opening, wherein the second opening has a pressing post inserted therein, and the second aperture has a steel ball fixed therein. A cover is locked on a lower end of the driving head and has a third opening defined thereon to insert the connecting stem.

### FIELD OF THE INVENTION

The present invention relates to a ratchet wrench with a fixing structure in which an actuating portion is positioned vertically or is rotated universally.

### BACKGROUND OF THE INVENTION

A conventional ratchet wrench contains an actuating portion wrench is rotated universally, but this actuating portion cannot be positioned vertically.

The present invention has arisen to mitigate and/or obviate the afore-described disadvantages.

### SUMMARY OF THE INVENTION

The primary object of the present invention is to provide a ratchet wrench with a fixing structure in which a pressing post of an actuating portion is pressed to drive a steel ball to move into a cutout of the pressing post, such that a socket is engaged with or disengaged from a connecting stem.

Another object of the present invention is to provide a ratchet wrench with a fixing structure in which the actuating portion is positioned by a cap of an octagonal ball, when it moves vertically or rotates universally.

To obtain the above objectives, a ratchet wrench with a fixing structure provided by the present invention contains: an operating handle, a driving head connecting with a front end of the operating handle, an accommodating cavity defined in the driving head, and a first opening defined in the accommodating cavity.

A toothed block is accommodated in the accommodating cavity and has an octagonal hole formed therein.

An actuating portion is accommodated in the octagonal hole of the toothed block and has an octagonal ball, an upper disc arranged on an upper end of the octagonal ball, a lower disc formed on a lower end of the octagonal ball, a peripheral groove defined between the upper disc and the lower disc, and a connecting stem extending downwardly from the lower disc.

The octagonal ball of the actuating portion has at least one first aperture defined on a peripheral side thereof, a spring and a cap which are both mounted in the at least one first aperture, and the actuating portion also has a second opening longitudinally passing through the actuating portion from the upper disc and communicating with a second aperture of the connecting stem, wherein the second opening has a pressing post inserted therein, and the second aperture has a steel ball fixed therein.

A cover is locked on a lower end of the driving head and has a third opening defined thereon to insert the connecting stem of the actuating portion.

### BRIEF DESCRIPTION OF THE DRAWINGS

FIG. 1 is a perspective view showing the assembly of a ratchet wrench with a fixing structure according to a preferred embodiment of the present invention.

FIG. 2 is a perspective view showing the exploded components of the ratchet wrench with the fixing structure according to the preferred embodiment of the present invention.

FIG. 3 is a cross sectional view taken along lines A-A′ of FIG. 1.

FIG. 4 is a cross section view showing the operation of the ratchet wrench with the fixing structure according to the preferred embodiment of the present invention.

FIG. 5 is another cross section view showing the operation of the ratchet wrench with the fixing structure according to the preferred embodiment of the present invention.

FIG. 6 is a cross sectional view taken along lines B-B′ of FIG. 1.

FIG. 7 is also another cross section view showing the operation of the ratchet wrench with the fixing structure according to the preferred embodiment of the present invention.

FIG. 8 is still another cross section view showing the operation of the ratchet wrench with the fixing structure according to the preferred embodiment of the present invention.

### DETAILED DESCRIPTION OF THE PREFERRED EMBODIMENTS

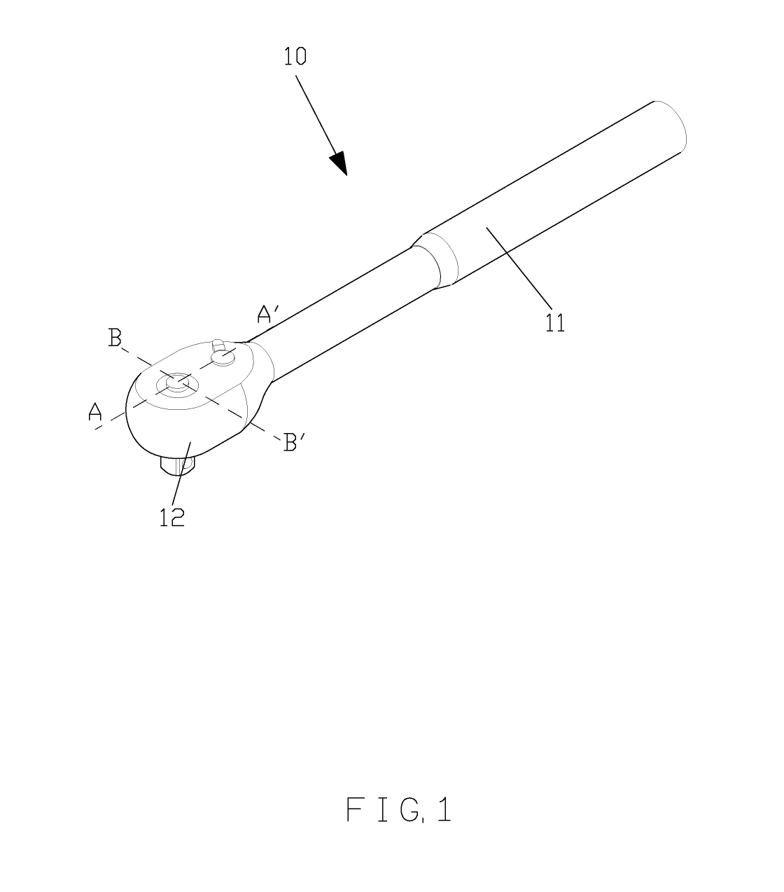

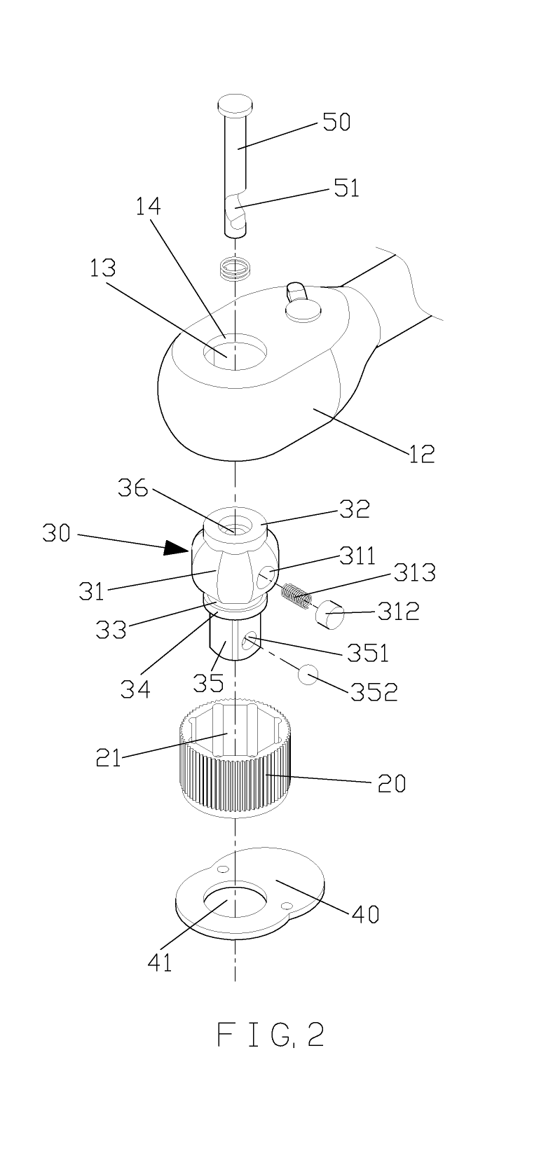

Referring to FIGS. 1 and 2, a ratchet wrench 10 with a fixing structure according to a preferred embodiment of the present invention comprises: an operating handle 11, a driving head 12 connecting with a front end of the operating handle 11, an accommodating cavity 13 defined in the driving head 12 to accommodate a toothed block 20, and a first opening 14 defined in the accommodating cavity 13, wherein the toothed block 20 has an octagonal hole 21 formed therein to accommodate an actuating portion 30. The actuating portion 30 has an octagonal ball 31, an upper disc 32 arranged on an upper end of the octagonal ball 31, a lower disc 34 formed on a lower end of the octagonal ball 31, a peripheral groove 33 defined between the upper disc 32 and the lower disc 33, and a connecting stem 35 extending downwardly from the lower disc 34. The octagonal ball 31 of the actuating portion 30 has at least one first aperture 311 defined on a peripheral side thereof, a spring 313 and a cap 312 which are both mounted in the at least one first aperture 311 to form an abutting device. The actuating portion 30 also has a second opening 36 longitudinally passing through the actuating portion 30 from the upper disc 32 and communicating with a second aperture 351 of the connecting stem 35, wherein the second opening 36 has a pressing post 50 inserted therein, and the second aperture 351 has a steel ball 352 fixed therein to form an engaging structure of the connecting stem 35 for engaging with or disengaging from a socket. In addition, a cover 40 is locked on a lower end of the driving head 12 and has a third opening 41 defined thereon to insert the connecting stem 35 of the actuating portion 30. It is to be noted that a diameter of the upper disc 32 of the actuating portion 30 is equal to that of the first opening 14 of the driving head 12, and a diameter of the lower disc 34 of the actuating portion 30 is equal to that of the third opening 41 of the cover 40.

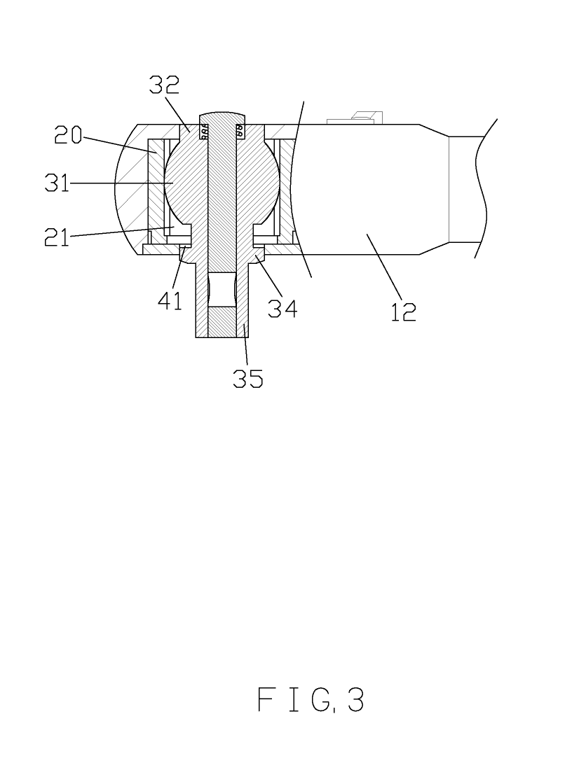

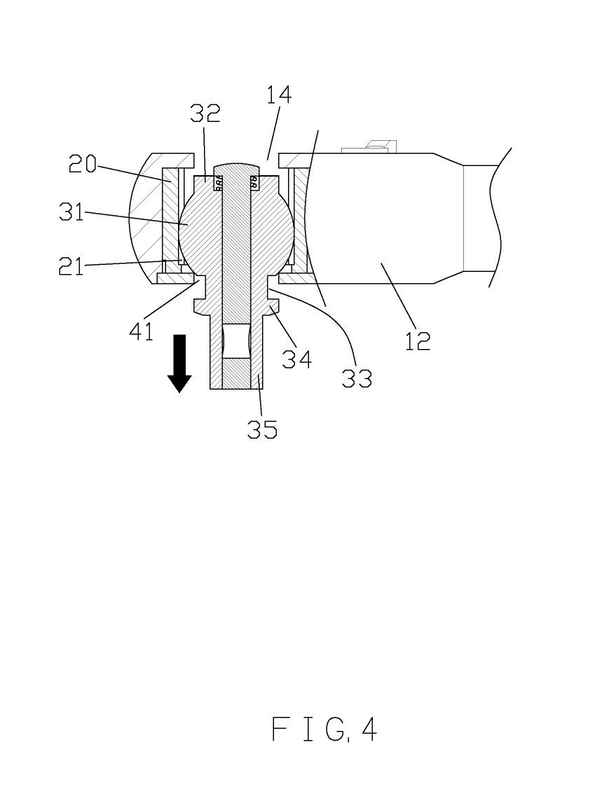

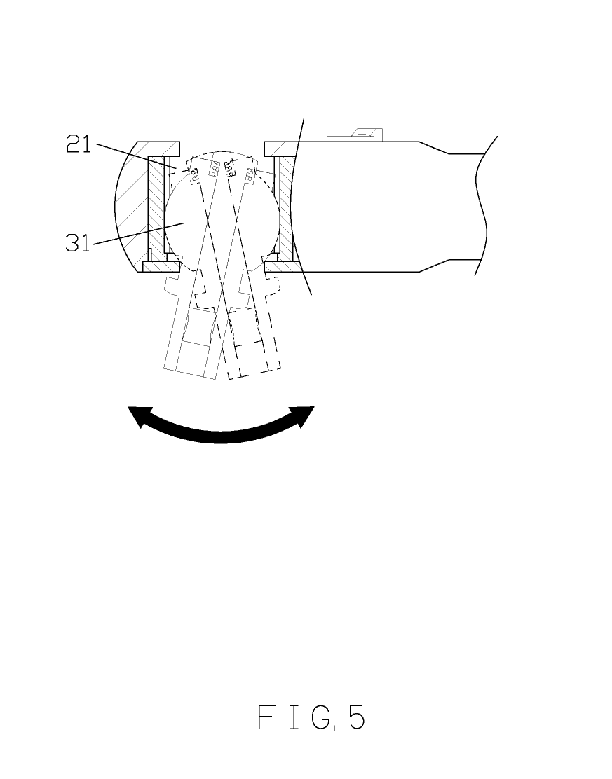

Referring to FIGS. 3 to 5, when the octagonal ball 31 of the actuating portion 30 retracts into an upper side of the octagonal hole 21, the upper disc 32 fits into and retains with the first opening 14 of the driving head 12, and the lower disc 34 contacts with the third opening 41 of the cover 40, such that the actuating portion 30 is fixed. After the actuating portion 30 is pulled toward a lower side of the octagonal hole 21, the upper disc 32 and the lower disc 34 disengage from the first opening 14 and the third opening 41, and the actuating portion 30 is rotated universally by ways of the octagonal ball 31 and the octagonal hole 21.

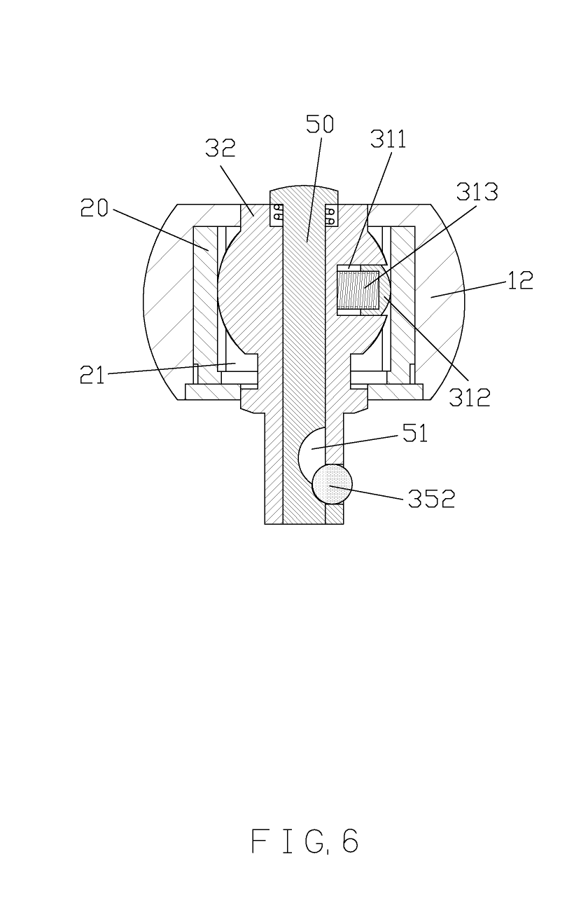

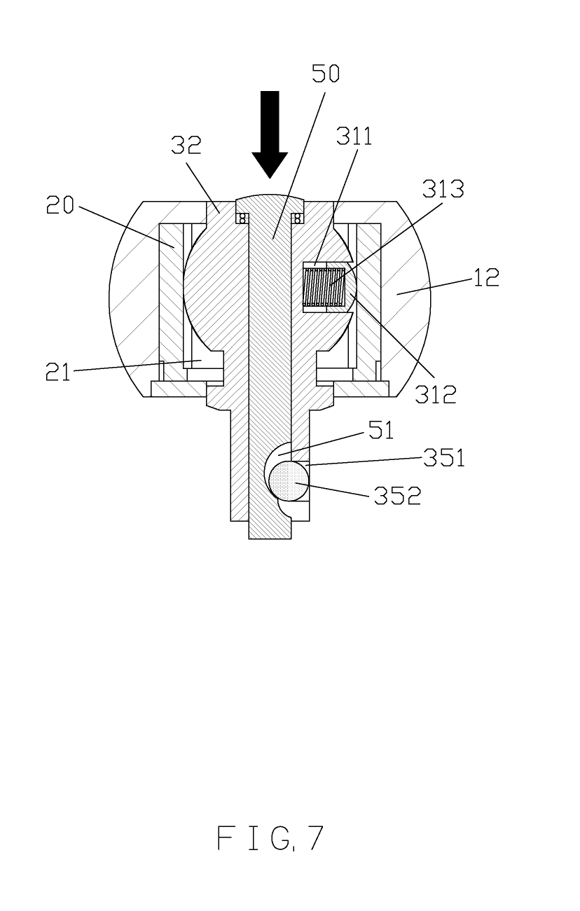

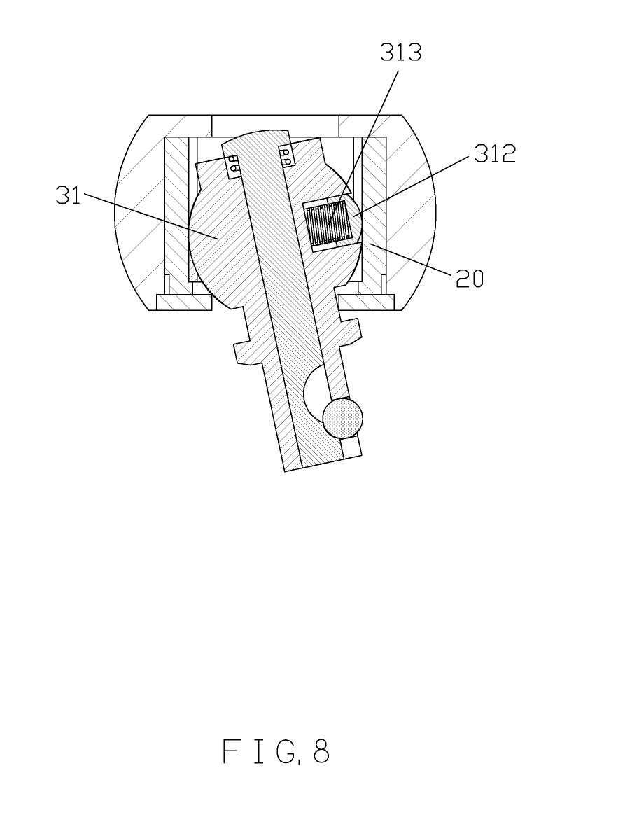

As shown in FIGS. 6 to 8, the pressing post 50 of the actuating portion 30 is pressed to drive the steel ball 352 to move into a cutout 51 of the pressing post 50, such that the socket is engaged with or disengaged from the connecting stem 35. Preferably, the actuating portion 30 is positioned by the cap 312 of the octagonal ball 31, when it moves vertically or rotates universally.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A ratchet wrench with a fixing structure comprising:
an operating handle, a driving head connecting with a front end of the operating handle, an accommodating cavity defined in the driving head, and a first opening defined in the accommodating cavity;
a toothed block accommodated in the accommodating cavity and having an octagonal hole formed therein;
an actuating portion accommodated in the octagonal hole of the toothed block and having an octagonal ball, an upper disc arranged on an upper end of the octagonal ball, a lower disc formed on a lower end of the octagonal ball, a peripheral groove defined between the upper disc and the lower disc, and a connecting stem extending downwardly from the lower disc;
the octagonal ball of the actuating portion having at least one first aperture defined on a peripheral side thereof, a spring and a cap which are both mounted in the at least one first aperture, and the actuating portion also having a second opening longitudinally passing through the actuating portion from the upper disc and communicating with a second aperture of the connecting stem, wherein the second opening has a pressing post inserted therein, and the second aperture has a steel ball fixed therein;
a cover locked on a lower end of the driving head and having a third opening defined thereon to insert the connecting stem of the actuating portion.

2. The ratchet wrench with the fixing structure as claimed in claim 1, wherein a diameter of the upper disc of the actuating portion is equal to that of the first opening of the driving head.

3. The ratchet wrench with the fixing structure as claimed in claim 1, wherein a diameter of the lower disc of the actuating portion is equal to that of the third opening of the cover.

4. The ratchet wrench with the fixing structure as claimed in claim 1, wherein the pressing post of the actuating portion is pressed to drive the steel ball to move into a cutout of the pressing post, such that a socket is engaged with or disengaged from the connecting stem.

5. The ratchet wrench with the fixing structure as claimed in claim 1, wherein the actuating portion is positioned by the cap of the octagonal ball, when it moves vertically or rotates universally.
